(19) United States
(12) Patent Application Publication
(10) Pub. No.: US 2008/0271325 A1
(43) Pub. Date: Nov. 6, 2008

(54) Barrier bracket assembly for a yard tool or the like

(76) Inventor: Edward Patrick Hurley, Sara Sota, FL (US)

Correspondence Address: Edward P. Hurley, 1214 Western Pine Cir, Sara Sota, FL, 34240, US

(21) Appl. No.: 12/217,917

(22) Filed: Jul. 10, 2008

Related U.S. Application Data
(63) Continuation of application No. 11/008,037, filed on Dec. 9, 2004, now abandoned.

(51) Int. Cl. A01D 34/416; A01D 34/82

(52) U.S. Cl. 30/276; 30/277.4; 30/288; 56/12.7

(57) ABSTRACT

A yard tool or unit having the motor barrier bracket upright when the tool barrier bracket and the control barrier bracket are rotated. The tool barrier bracket having flared operator and tool nozzle shields, a front suspension, one or more line filament or bladed tools, uniform air intake open to a fan to discharge debris and hold lubricants in a chamber. The front suspension fixed or to dial into tool heights and balance the unit. The tool output combines for no more than 200 rpm variance of motor input. The control barrier bracket having to mount a handlebar near the unit fixed point with a neighboring tool control grip, power control grip and transmission. The neighboring control grip to rotate the line filament or bladed tool in the right or left single fold operating framework free of collapsing.

### CROSS REFERENCE TO RELATED APPLICATIONS

This is a continuation of Ser. No. 11/008,037, filed on Dec. 9, 2005.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates to the field of grounds maintenance and more specifically to a barrier bracket assembly for a yard tool or the like.

Many handheld yard tools are capable of transmitting input power from a motor to a line filament or bladed tool. A lubricated drive shaft will typically translate motor input within a boom barrier to a working output end with one or more tool attachments. There are three common yard tool brackets that hold a boom barrier together, namely, a motor barrier bracket, a control barrier bracket and a tool barrier bracket can all be joined together to function as one barrier. The main barrier brackets are not limited to the scope of other bracket applications, sub-bracket add-ons and bracket overlap options.

A yard tool may alter main barrier bracket roles based on where tool attachments are centralized. For example, some bladed hedge trimmers and chainsaws will provide a protective shield at or near a control barrier bracket region whereas elongated line filament grounds tools and elevated power pruning devices will have a protective shield found at a tool barrier bracket portal while relatively large handheld or backpack blowers will usually protect an operator from a motor barrier bracket air intake region. Several barrier bracket bases will have a flat skid portion used to help stabilize power tool equipment during frequent power tool start-ups and other idle tool situations. Accordingly, barrier bracket add-ons must be able to absorb tool shock in order for landscape power units to continue in a safe working mode. Moreover, two or more steps to rotate line filament tool string trimmers will likely prevent accidents whereas a quick one or two step process may be needed to immediately break free from more rigid bladed yard tools.

By and large, motor barrier brackets involve protective measures to avert operators from being exposed to fast moving parts and their integral substances. Motor barrier brackets have a secondary purpose of providing superior downward force potential from a rearward boom end to relieve a tool load at the boom other end without sacrificing output power. Thus, it becomes apparent that setting a motor in an upright position behind an operator offers more flexibility to focus on primary tool functions; especially when working over imbalanced terrain. This isn't to say that a motor can't be placed between a tool and control barrier bracket region so that one or more power sources can balance a grounds operation at a motor barrier bracket end.

Another advantage of a motor or power source being balanced from behind an operator is that a “caution-stay clear” sign can be posted at a motor barrier bracket end to restrict workers from being suddenly tapped from behind by a trainer. Some experts believe that approaching a trainee from behind a guard is safe, but this could lead to sudden lateral tool movement into bystanders. Having said that, it is preferable that bystanders alert maintenance providers from about one-hundred feet ahead of operations to remain beyond a fifty feet separation until all power units have come to a complete stop within the inner restricted area. Line filament string trimmers, as a whole, run a lot smoother and longer when the motor barrier bracket stays upright with respect to a tool operation or orientation.

A control barrier bracket is preferably placed near a yard tool fixed point so that a variety of handlebar configurations can be fitted to an operator. Yard tool handlebar systems generally include a tool control grip for guiding tool barrier bracket functions. A tool control grip must be at least ten inches apart from a power control grip which serves a dual purpose to stabilize motor barrier bracket functions while a tool is made operable. Grip surfaces, particularly surfaces with one or more pressure points, may have a soft outer coating made into four or more inch slight bends for added hand or arm comfort. A lateral bar of eight inches or more and an adjustable loop harness are occasionally installed on control barrier brackets to prevent operators from entering into a tool barrier bracket region. A front suspension added to a tool barrier bracket and a span harness installed between control and motor barrier brackets will further limit tool kickback and will dampen typical teeter tauter longitudinal boom disturbances.

Tool barrier bracket additions are normally integrated at a yard tool working end to maximize tool output while minimizing residual momentum. For instance, a wheel suspension can be made five times smaller than a control barrier bracket counterpart. In addition, a large amount of tool resistance can be absorbed at a tool location prior to reaching a control barrier bracket junction. Indeed, substantial energy can be saved when a wheel support is used to separates trees, bushes and property improvements from a threat of tool invasion and shock. Introducing a wheeled support at a tool end will improve balance of asymmetrical debris shields as well. Front suspensions are excellent cross training members for light vertical line filament and more rigid bladed lawn edging work.

Historically speaking, many inventions have incorporated cooling fans into tool barrier brackets without noting serious problems associated with orthogonal walls and broad canopies that gather debris to choke off machine parts from operating properly like U.S. Pat. No. 6,130,819. This ventilation breakdown at sharp bends is further aggravated when excessive air pressure sucks lubricant bonds from chambers. An interesting byproduct of high air pressure occurs when a front suspension and a tool shield are not properly implemented for grounds work. In this case, an operator may have a daunting task of removing a pound or more of substance from a longer and faster helical boom chamber after grease is repeatedly sucked up into the boom after a slower helical reverse gear chamber is filled up again with grease by a tool mechanic. Lubricants can be squeezed into a slower moving tool barrier bracket chamber by gravity and centrifugal force which should be regularly inspected for debris and lubricant leaching; especially when a front suspension isn't utilized for yard work. Drawing out lubricants at critical bracket barrier junctions will only lead to more friction and wear of parts. In some cases, one or more front suspensions can be used effectively for supporting a lot of mass like the suspension found in U.S. Pat. No. 5,930,083 which may work for permanent lawn edging tasks, but ground maintenance could become rough when carrying multiple cutter and blower disks on long journeys instead of CD's.

There have been prior efforts made to improve some of the tool barrier bracket setbacks. US D 530163 S and US D 563740 S illustrate a tool barrier bracket and fixed wheel suspension for yard grounds trimming and lawn edging. U.S. Pat. No. 4,507,865 consists of a tool barrier bracket with folded steel to reduce the weight at a yard tool working end. U.S. Pat. No. 6,769,185 B2 facilitates a vented interior lubricant filling inside the portal bracket to relief pressure on lubricants. U.S. Pat. No. 20020116826 A1 implements a dust cup to keep flying debris away from the tool barrier bracket. U.S. Pat. No. 7,111,404 B2 provides a spacer or shield apparatus to prevent or at least minimize the accumulation of vegetative matter on an output shaft. U.S. Pat. No. 6,357,411 B1 describes a uniform intake. The U.S. Pat. No. 4,200,978 objective is to offer a secondary shield beneath a primary tool barrier bracket shield to prevent tool attachments from slowing or stopping. Finally, U.S. Pat. No. 4,101,156 is a barrier bracket clamping ring useful for containing metals and other materials.

The US D '3 & 0 S tool barrier bracket align an operator with the vertical operating path to potentially cause slips and falls; especially along steep retaining walls and tight roadside curbs. The '3 & 0 S front wheel suspensions are permanently attached to a fatigue prone tool barrier bracket side. The '3 & 0 S designs require several cumbersome steps to orientate the tool into a second operating position. US D '3 & 0 S can potentially be extended and pivoted at a cutter origin to fit under a deck to trim normally hidden vegetation in a lower and more stressful position, but a low operator stance could further expose low flying projectiles to an operator, not to mention increased risk of injury when a '3 & 0 S motor barrier bracket is lifted up and backed away from decks which will likely send excessive amounts of loose grounds material back towards operators. The US D '3 & 0 S inventions have added weight at the critical tool end with a flower guard that can easily be eliminated and replaced with an advanced front suspension that will also protect against harm to sensitive lawn care objects. Double helix line filament of '3 & 0 S will vibrate more than three dimensional line filament. Designs '3 & 0 S consist of a split tool barrier bracket exposed to a tool working side that will likely draw in dust to a motor. The '3 & 0 S motors seem to be attached within a tool barrier bracket region to shorten the yard tool use cycle. Inventions '3 & 0 S could pose a serious heat concern; particularly because ANSI limits vertical resistance impact tests for most yard tools. The '3 & 0 S protective shield is prone to flutter line filament when one or more concave dimples face the tool working side. Design Patents '3 & 0 S appear to leave out a nozzle to disperse debris away from the tool barrier bracket end. The '3 & 0 S handlebars may draw a small operator into a tool region when a frontal grip is rotated forward and possibly shred line filament faster as well as increase discomfort to a tall operator when the '3 & 0 wheel can't adjust a tool height with cumbersome end user ergonomic heights.

The '865 invention has limited cooling capabilities for the grease cup when it is under high resistance and there isn't an appropriate tool shield to disperse debris once it gathers from a hole opening. Excessive yard tool activity can build up heat to break down lubricants within the '185 B2 tool barrier bracket portal. It would be difficult for an operator to thoroughly inspect '185 B2 for lubricant loss which could permit excessive amounts of grease to weigh down the tool. U.S. Pat. No. '185 B2 doesn't offer enough flow of ambient air to cool the bracket housing. U.S. Pat. No. '185 B2 provides a cone shape, but tangential lubricants tend to flow outward in wider cavities making it difficult to hold films onto upper drive parts. The '185 B2 invention can actually force thick lubricants about four feet up into the motor since it is designed with a vent and no lubricant back flow device. The '404 B2 tool bracket portal has an orthogonal shield or wall that holds back debris and adds unnecessary weight to the operation. This is because the '404 B2 stack is used more as a rigorous vacuum tube when one or more of the adapter notches rotate at very high speeds. Debris gets lodged inside the '404 B2 bracket annular space causing the breakdown of lubricants and build up of heat. Although '411 B1 has uniform air intake, the device is heavy and could fatigue an operator. The '411 B1 invention doesn't immediately disperse debris away from the tool. Invention '978 is more likely to slow or stop because the shield has an air intake that faces the working side to force excessive amounts of debris into the tool housing chamber. The '978 material appears to add unnecessary shield and debris weight to the grounds care operation which encourages more body part leaning and equipment scalping of vegetation. Even though U.S. Pat. No. '156 has means to lubricate inner parts better than cone shaped containers, the sealed barrier bracket doesn't provide proper yard tool ventilation to counter resistance. The three step clamping seal of '156 is noteworthy, but it is somewhat cumbersome for dialing or rolling important metallic filled barrels over soft vegetation.

In order to improve some of these prior art shortcomings, a parabola or steady bend nozzle must be utilized instead of harsh orthogonal walls that block airflow and debris like that of '163 S, '728, '404 B2, '865 and '156 deflection shields located at the base of a tool barrier bracket, then a disk with outer air vanes can be aligned with a uniform air intake to draw ambient air and lubricants in while disbursing debris away from the tool barrier bracket. Keeping the tool barrier bracket inner chamber more cylinder in shape optimizes the distribution of lubricants while airflow retains the lubricants in a cleaner manner. Fanning the adjacent cylinder drum with ambient airflow will cool the lubricated drive parts as well. What's more is that a new and improved lightweight front suspension relieves air pressure on yard tools to hold in more lubricants.

### BRIEF SUMMARY OF THE INVENTION

The primary object of the invention is to provide a yard tool (“unit”) with one or more improved barrier brackets to optimize the unit balance.

Another object of the invention is to provide the unit with a host of lightweight tool attachment options.

Another object of the invention is to provide superior orientation of the unit which facilitates greater grounds maintenance awareness.

A further object of the invention is to provide the unit with uniform and continuous

A further object of the invention is to provide the unit with uniform and continuous ambient air intake and debris disbursement.

Still yet another object of the invention is to provide a plurality of cylinder chambers to make the unit more efficient and affordable.

Another object of the invention is to provide the unit with forward grounds operations to conserve energy and promote good health.

Another object of the invention is to provide the operator and bystanders with better control of outdoor power equipment along with more appropriate unit noise levels.

A further object of the invention is to provide more ventilation at critical points to reduce strain on materials.

Yet another object of the invention is to provide reliable tool and shield protection for improved safety and cleaner lubricants.

Yet another object of the invention is to provide the unit with less air pressure to retain more lubricants.

Still yet another object of the invention is to provide consistent input and output power to a host of tool attachments.

Yet another object of the invention is to remove weight at the unit tool when a front suspension is not required for long periods of open grounds maintenance.

A further object of the invention is to provide the unit with a front suspension that is fits in a pocket, stows in glove box or hooks on a belt loop when unneeded.

Another object of the invention is to cross train end users with a line filament tool front suspension so that landscapers can easily adapt to vertical bladed lawn stick edgers.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a barrier bracket assembly for a yard tool or the like sometimes referred to as the unit comprising: a motor, a drive shaft, a line filament tool or a bladed tool, the motor transmits input power from the drive shaft to the tool barrier bracket output power, a boom, having means to connect a tool barrier bracket assembly, a motor barrier bracket and a control barrier bracket on a center line of rotational symmetry, having means for sub-bracket add-ons and bracket overlays, the control barrier bracket having means for a plurality of handlebars to connect at or near the unit fixed point, having means for a bar barrier, having means for a loop and span harness or the like, having means for a transmission, the transmission having means to transfer input power between the line filament and bladed tools, having means to restrict the handlebar to maximum or minimum ergonomic tolerances, the harness having means to maintain an upright position when the tool barrier bracket rotates, the handlebar having means for the power control grip to manage the motor barrier bracket operations at least ten inches from center of a neighboring tool control grip that manages the tool barrier bracket operations, having means to translate or rotate away from the tool barrier bracket free of collapsing, the tool control handle and the power control handle having means to rotate the tool barrier bracket into a right or a left single fold operating framework, the motor barrier bracket having means for two or more steps to release from the tool barrier bracket, the motor barrier bracket and power control grip having means to reverse mirrored single orthogonal folds with the tool barrier bracket and the tool control grip, having means to separate from the tool barrier bracket and the tool control grip with two or more elongated overlay steps, the motor barrier bracket having means for the motor, a carburetor, a trigger cable, a trigger control, a power source, a power cord and adapter, a heat stack, a tool lever, a power cut off switch, a throttle control latch, a vented casing, a power control handle, a harness clip fitting and an impact skid to maintain a horizontal upright position with respect to the tool barrier bracket operation, the trigger control, the power control grip and the tool control grip having means for a plurality of resilient surfaces, the vented casing having means to strengthen the motor barrier bracket in an upright position, the tool barrier bracket operatively having one or more line filament or bladed tool attachments, a tool shield, one or more uniform ambient air intakes, a cylinder barrel chamber and a convex rim, having means for a front suspension, having means for an operator shield, having means to substantially withstand the line filament or bladed tool operations, the convex rim having means for a resilient dampener, the barrel chamber having means to reverse, slow and torque up the motor input, having means to maintain uniform pressure on lubricants, the operator shield having one or more arch supports, a skid, one or more dimples facing the handlebar, having means to reduce thickness from a distal end to a proximal end, the arch supports having means to flare out from the proximal end to the distal end, the skid having a flat mid-section, having means to rest the unit flat, having means to support the tool barrier bracket when the unit is held, the operator shield having means for one or more shield blades, having means to maintain length of the flexible line tool, having means to cut the line filament from the smallest conic width, having means to stabilize the line filament and bladed tool disturbances, having means to optimize the unit output, having means to substantially protect an operator along loose, soft and hard grounds surfaces, the tool shield having a concave rim having means to separate the line filament or bladed tools into a cutter and a fan, the cutter and fan having means to maintain the motor input at no more than 200 rpm variance when operated at wide open throttle, the concave rim of the tool shield centers with the convex rim of the tool barrier bracket to form an open shell, the shell having means for an open nozzle, the fan having one or more circumferential air vanes that tangentially align with one or more uniform ambient air intakes, having one or more ring barriers that tangentially align with the barrel chamber, having means to stabilize air pressure within the barrel chamber, having means to disperse dust, gases and debris from the shell, having means to stabilize the line filament and bladed tool, having means to quiet the unit, the air intake substantially blocked from lubricants, the air intake having means to dislodge one or more of the line filament or bladed tools from the unit, the tool shield having means to self-clean and reduce wear to the tool barrier bracket and unit, the tool shield having means to cool the tool barrier bracket and force debris from the operator shield, the tool shield having means to hold lubricants into a barrel chamber of the tool barrier bracket, the barrel chamber having means for uniform lubricant films, the front suspension having means to mount a frame over the resilient dampener to the convex rim at a proximal end, having means for one or more roller wheels at a distal end, having means for a vent with open visibility, having means to lower debris and machine weight, having means to maintain a fixed position or dial into more tool height or add width to the operator shield, having means to limit the tool height positions, having means to support

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention illustrating the unit with a control barrier bracket and a tool barrier bracket orientated in a vertical position with respect to a motor barrier bracket maintaining an upright position and a front suspension supporting the unit at ground level.

FIG. 2 is a partial top view of FIG. 1 illustrating the front suspension in a fixed embodiment of the invention orientated to protect sensitive frontal objects while an operator shield serves to protect rearwardly from a line filament or a bladed tool.

FIG. 3 is a partial perspective view of FIG. 1 illustrating a bladed tool and the operator shield embodiment of the tool barrier bracket with a schematic outlining the direction of uniform air intake and debris outflow.

FIG. 4 is a partial exploded perspective view of FIG. 1 illustrating the front suspension and the tool shield embodiment of the tool barrier bracket.

the unit in a vertical position over hard pavement surfaces, having means to maintain the line filament or bladed tool behind sensitive frontal property improvements and vegetation at all times, having means to protect the line filament or bladed tool from high resistance over hard pavements and the like at all times; having means to minimize tool disturbances; having means to press down on tall vegetation evenly with the operator shield, having means to limit vegetation wrap around the unit, having means to guide forward progress of the unit, having means to substantially reduce operator and tool fatigue during transport and operation, having means to stow away when the unit is operated along loose or soft grounds cover, having means to align ninety degrees from the nearest operator shield radian side wall and having means to balance the unit during a primary blower operation or the line filament or bladed cutter operations, having means to fit in a pants pocket, stow in a glove box or hook onto a belt loop, the line filament and bladed tool outputs combine for no more than 200 rpm variance of the motor input at wide open throttle, having means to reverse, reciprocate and alter speeds and motions, having means to maximize the cutter and the fan performances while minimizing grounds disturbances, and having means to cool the tool barrier bracket.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

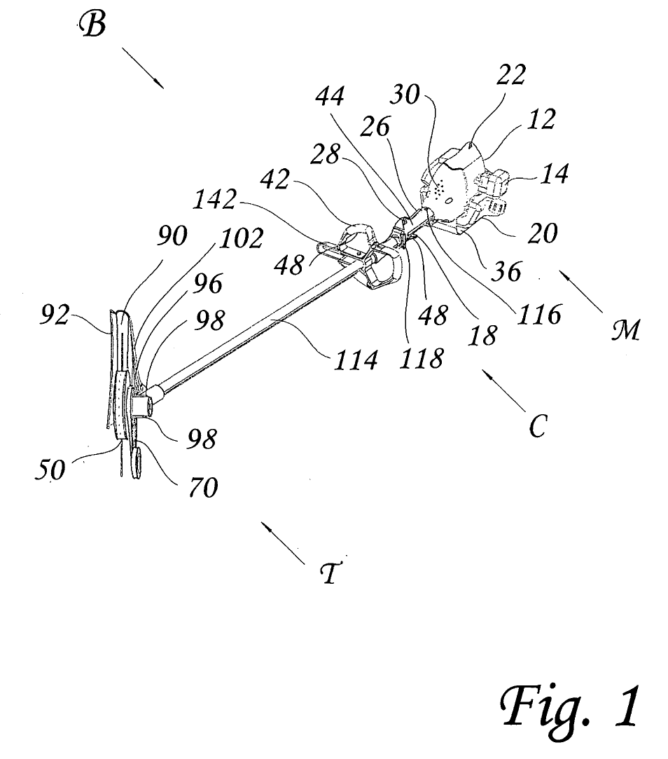

Referring to FIG. 1, A barrier bracket assembles into a yard tool commonly referred to as the unit B, specifically comprising three barrier brackets, that is, a tool T, a control C and a motor M barrier bracket to transmit input power from a motor 12 to a line filament 50 or a bladed 60 tool. The motor 12 transmits input power from the drive shaft 38 within a straight or bowed boom 114. The boom 114 having to connect the tool T control C, and motor M barrier brackets on a center line of rotational symmetry. The unit B or boom 114 can provide additional sub-bracket add-ons and translation 116 or rotational 118 bracket overlays according to sound engineering judgment.

The control barrier bracket C having a plurality of handlebar configurations to connect at or near the unit B fixed point. An auxiliary bar barrier 142 can be attached to the control barrier bracket C and will extend out at least eight inches to prevent the tool barrier bracket T from lateral kickback into an operator. In addition, an auxiliary loop or span harness and the like (not shown) will connect to a harness clip fitting 34 to control the tool T and motor M barrier bracket disturbances. The control barrier bracket C provides means for a transmission 110 that will transfer substantial input power between the line filament 50 and bladed 60 tools and will orientate the handlebar in several standard ergonomic positions. The control barrier bracket C or handlebar provides for a power control grip 44 to manage the motor barrier bracket M operations at least ten inches from center of a neighboring tool control grip 42 that manages the tool barrier bracket T operations and orientations. The control barrier bracket C will translate or rotate away from the tool barrier bracket T free of collapsing. The tool control handle 42 and the power control handle 44 can rotate the tool barrier bracket T into a right or a left single fold operating framework. The motor barrier bracket M has means for two or more steps to release from the tool barrier bracket T, that is, a translation 116 and a rotation 118 lock, at a minimum, couples the elongated motor barrier bracket M and the tool barrier bracket T overlays firmly and safely together. The motor barrier bracket M and power control grip 44 having means to reverse mirrored single orthogonal folds with the tool barrier bracket T and the tool control grip 42.

The motor barrier bracket M has means for the motor 12, a carburetor 14, a trigger cable 16, a trigger control 18, a power source 20, a power cord and adapter (not shown), a heat stack 22, a tool lever 24, a throttle control latch 26, a power cut off switch 28, a vented casing 30, the power control grip 44, a harness clip fitting 34 and an impact skid 36 to maintain a horizontal upright position with respect to the tool barrier bracket T operation and orientations.

The trigger control 18, the power control grip 44 and the tool control grip 42 surfaces 46 may be insulated with a number of different resilient liners or coatings; especially at key pressure points 48. The vented casing 30 has means to strengthen the motor barrier bracket M because the lower and sideward sections require less venting.

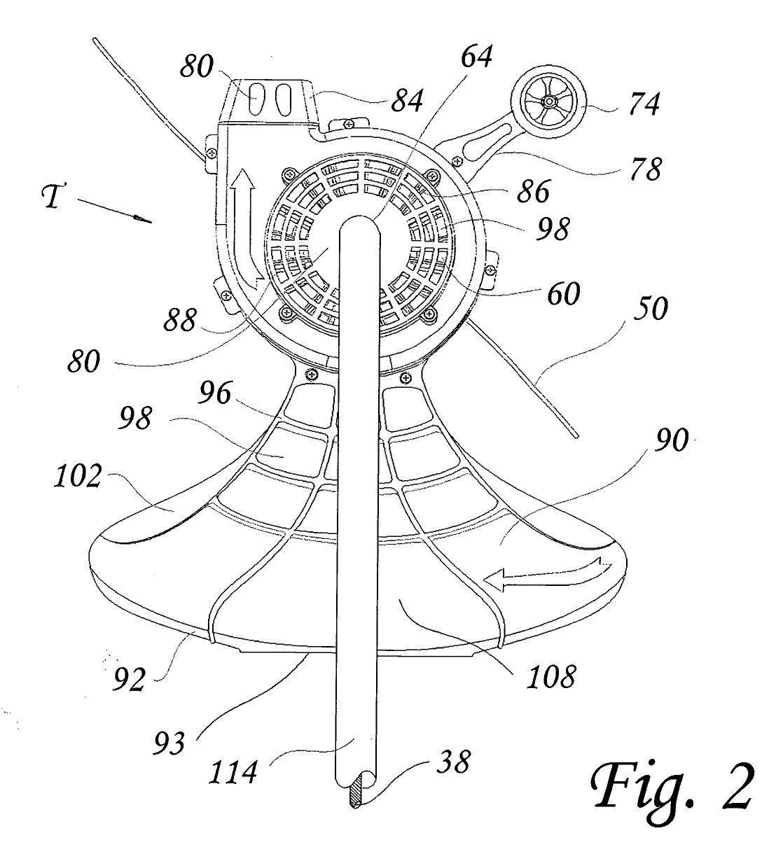

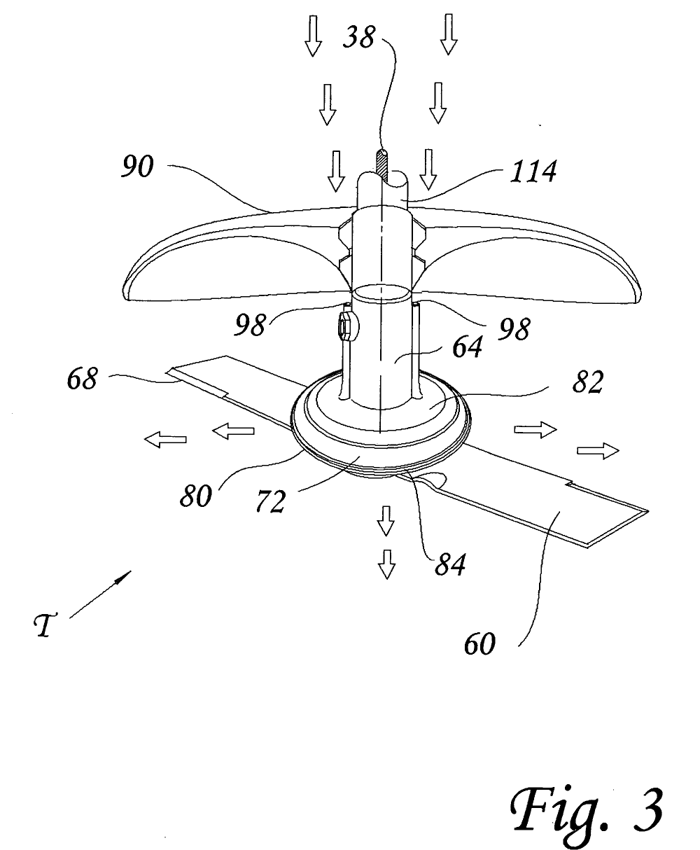

Referring to FIG. 2-FIG. 4, the tool barrier bracket T facilitates one or more of the line filament 50 or bladed tool 60 attachments to maintain similar vertical or horizontal tangential work output patterns. A tool shield 80 attaches to the base of the tool barrier bracket T to form a concave rim 52. A barrel chamber 64 is capable of evenly distributing film lubricants within the tool barrier bracket T away from an outer convex rim 66 base. The barrel chamber 64 will reverse, slow and torque up the motor 12 input while maintain uniform pressure of lubricants on the drive shaft 38. The tool barrier bracket T has means for a front suspension 70 which will be explaining in more detail below. The tool barrier bracket T generally provides lightweight metallic materials or the like at a proximal end and ABS or the like at one or more distal ends to substantially withstand the line filament 50 or bladed tool operations 60.

The operator shield 90 has one or more arch 96 or beam supports with a thickness that rises from a distal end to a proximal end. The operator shield 90 further has a skid 92 having a flat mid-section 93 with means to rest the unit B flat and to support the tool barrier bracket T when the unit B is held. The operator shield 90 has one or more dimples 108 facing the handlebar or control barrier bracket C. The operator shield 90 arches 96 or beam supports can reduce thickness and flare inward at outer side wall 102 positions from a distal end to a proximal end. The operator shield 90 has one or more shield blades (not shown) to maintain length of the flexible line tool 50 and to cut the line filament 50 from the smallest conic width in order to stabilize the line filament 50 and bladed 60 disturbances. Accordingly, the operator shield 90 is meant to optimize the unit B output to substantially protect an operator along loose, soft and hard grounds surfaces.

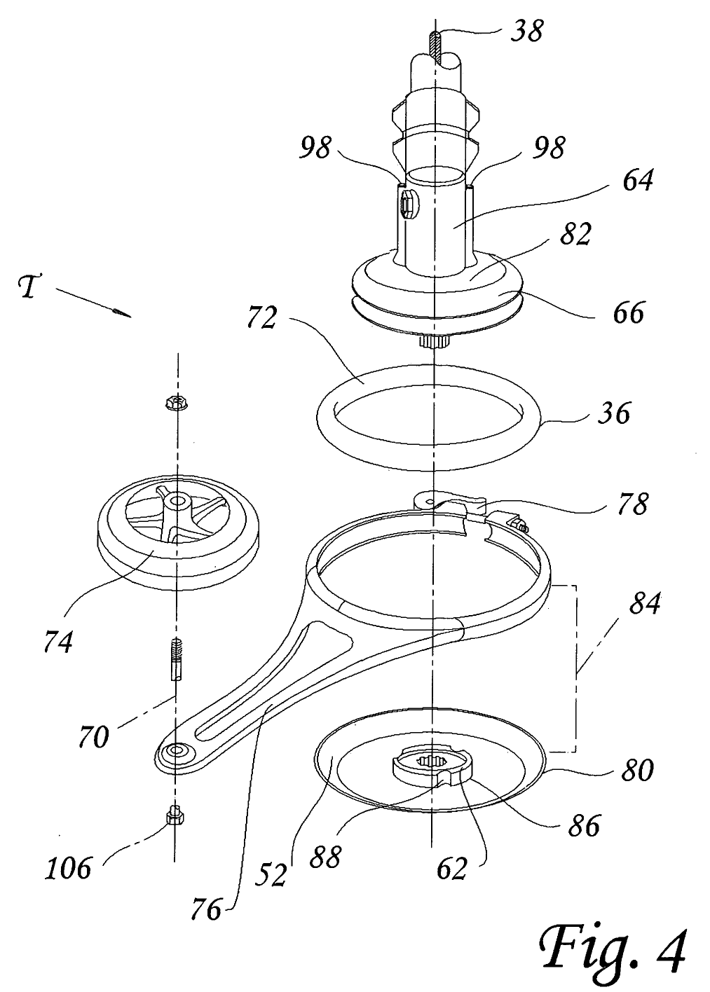

Referring more specifically to FIG. 4, the convex rim 66 has means for a resilient dampener 72 of a ring, tube or other shape according to sound engineering judgment. The dampener 72 absorbs shock before it translates into the tool barrier bracket T from the front suspension 70, the line filament 50 and bladed 60 tool operations.

Referring back to FIG. 1-FIG. 4, the tool shield 80 shown in FIG. 4 has a concave rim 80 embodiment to separate the line filament tool 50 from the bladed tool 60 for implementing either the line filament 50 or bladed tool 60 as a main cutter 68 or a main blower fan 86, respectively, but the tool shield 80 can also separate the tool barrier bracket T tool attachments into two or more bladed 60 tool attachment configurations or a single line filament 50 or single bladed 60 tool attachment embodiment. The line filament 50 and bladed 60 tools maintain the drive shaft 38 input at no more than 200 rpm variance when the motor 12 is operated at wide open throttle. The concave rim 52 that extends outward from the tool shield 80 centers axial with the convex rim 66 that extends outward from the tool barrier bracket T base 82 to implement a shell that forms into an open nozzle 84 at the tool barrier bracket T base 82 distal end. The nozzle 84 discharges ambient air and debris from one or more uniform ambient air intakes 98 that align with one or more circumferential air vanes 88 of the fan 86. The convex 66 and the concave 52 rims are substantially sealed by one or more ring barriers 62 that tangentially align with the barrel chamber 64 to stabilize air pressure within the barrel chamber 64 and to disperse dust, gases and debris from the shell. The tool shield 80 has means to stabilize the line filament 50 and bladed tool 60 and has capability to quiet the unit B. The air intake 98 substantially blocked from the barrel chamber 64 lubricants and can dislodge one or more of the line filament 50 or bladed 60 tools from the unit B. The tool shield 80 will self-clean to reduce wear to and cool the tool barrier bracket T and unit B which further has an ability to hold lubricants into a barrel chamber 64 with uniform lubricant films.

Referring now to FIG. 2 and FIG. 4, the front suspension 70 has a frame 76 that may mount over the resilient dampener 72 at the convex rim 66 distal end with a cam lock 78 or the like, but the frame 76 may provide independent dampening qualities and connect to the convex 66 and concave 52 rims as partially shown in FIG. 1. The resilient dampener 72 can be left independently on the convex rim 66 to provide an impact skid 36. The frame 76 has a vent for more visibility and to lower debris gathering and machine weight. The front suspension 70 is capable of limiting the tool height positions or dial into one or more tool barrier bracket T height positions or will add width to the operator shield 90 with the use of the cam lock 78. One or more roller wheels 74 will fasten at the frame 76 distal end by a bolt 106 or the like. The front suspension 80 is to support the unit B in a vertical operating position over hard pavement surfaces and will stow away when the unit B is operated along loose or soft grounds cover. The front suspension 80 has means to maintain the line filament 50 or bladed 60 tools behind sensitive frontal property improvements and vegetation at all times and guide forward progress of the unit B while providing means to protect the unit B and operator from high resistance over hard pavements and the like. The front suspension 80 will align approximately ninety degrees from the nearest operator shield 90 radian side wall 102 to balance the unit B during a primary blower 60 operation or the line filament 50 or bladed cutter 60 main operations. Furthermore, the front suspension 80 will minimize tool disturbances and press symmetrically down on tall vegetation evenly with the operator shield 90 side walls 102, nozzle 84 to limit vegetation wrap around the unit B. The front suspension 80 and the tool barrier bracket T are capable to substantially reduce operator and unit B fatigue during transport and operation. The front suspension 80 will also fit in a pants pocket, stow in a glove box or hook onto a belt loop when unneeded.

The line filament 50 and bladed 60 tool outputs combine for no more than 200 rpm variance of the motor 12 input power at wide open throttle to reverse, reciprocate and alter speeds and motions or the filament cutter and the bladed fan performances or combination thereof while minimizing grounds disturbances and to maintain cool temperatures on the tool barrier bracket T and unit B.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A barrier bracket assembly for a yard tool or the like comprising:
the yard tool sometimes referred to as the unit;
a motor;
a line filament tool;
a bladed tool;
a drive shaft;
a boom, having means to connect a tool barrier bracket, a motor barrier, a control barrier bracket and a motor barrier bracket on a center line of rotational symmetry, having means for additional sub-bracket add-ons and translation or rotational bracket overlays;
the motor transmits input power from the drive shaft to the tool barrier bracket output power;
the control barrier bracket having means for a plurality of handlebars to connect at or near the unit fixed point, having means for fastening by hand or according to sound engineering judgment, having means for a bar barrier, having means for a loop and span harness or the like, having means for a transmission;
the barrier bar having means to extend the handlebar to at least eight inches in a lateral direction from the boom;
the transmission having means to transfer input power between the line filament and bladed tools, having means to restrict the handlebar to maximum or minimum ergonomic tolerances;
the harness having means to maintain an upright position when the tool barrier bracket rotates;
the handlebar having means for the power control grip to manage the motor barrier bracket operations at least ten inches from center of a neighboring tool control grip that manages the tool barrier bracket operations, having means to translate or rotate away from the tool barrier bracket free of collapsing;
the tool control grip and the power control grip having means to rotate the tool barrier bracket into a right or a left single fold operating framework;
the motor barrier bracket having means for two or more steps to release from the tool barrier bracket;
the motor barrier bracket and the power control grip having means to reverse mirrored single orthogonal folds with the tool barrier bracket and the tool control grip, having means to separate from the tool barrier bracket and the tool control grip with two or more elongated overlay steps;
the motor barrier bracket having means for the motor, a carburetor, a trigger cable, a trigger control, a power source, a power cord and adapter, a heat stack, a tool lever, a throttle control latch, a power cut off switch, a vented casing, the power control grip, a harness clip fitting and an impact skid to maintain a horizontal upright position with respect to the tool barrier bracket operation,
the trigger control, the power control grip and the tool control grip having means for a plurality of resilient surfaces;
the vented casing having means to strengthen the motor barrier bracket in an upright position;
the tool barrier bracket operatively having one or more line filament or bladed tool attachments, a tool shield, one or more uniform ambient air intakes, a cylinder barrel chamber and a convex rim, having means for a front suspension, having means for an operator shield, having means to substantially withstand the line filament or bladed tool operations;
the convex rim having means for a resilient dampener;
the barrel chamber having means to reverse, slow and torque up the motor input, having means to maintain uniform pressure on lubricants;
the operator shield having one or more arch supports, a skid, one or more dimples facing the handlebar, having means to reduce thickness from a distal end to a proximal end;
the arch supports having means to flare out from the proximal end to the distal end;
the skid having a flat mid-section, having means to rest the unit flat, having means to support the tool barrier bracket when the unit is held;
the operator shield having means for one or more shield blades, having means to maintain length of the flexible line tool, having means to cut the line filament from the smallest conic width, having means to stabilize the line filament and bladed tool disturbances, having means to optimize the unit output, having means to substantially protect an operator along loose, soft and hard grounds surfaces;
the tool shield having a concave rim having means to separate the line filament or bladed tools into a cutter and a fan;
the cutter and fan having means to maintain the motor input at no more than 200 rpm variance when operated at wide open throttle;
the concave rim of the tool shield centers with the convex rim of the tool barrier bracket to form an open shell;
the shell having means for an open nozzle;
the fan having one or more circumferential air vanes that tangentially align with one or more uniform ambient air intakes, having one or more ring barriers that tangentially align with the barrel chamber, having means to stabilize air pressure within the barrel chamber, having means to disperse dust, gases and debris from the shell, having means to stabilize the line filament and bladed tool, having means to quiet the unit;
the air intake substantially blocked from lubricants;
the air intake having means to dislodge one or more of the line filament or bladed tools from the unit;
the tool shield having means to self-clean and reduce wear to the tool barrier bracket and unit;
the tool shield having means to cool the tool barrier bracket and force debris from the operator shield;
the tool shield having means to hold lubricants into a barrel chamber of the tool barrier bracket;
the barrel chamber having means for uniform lubricant films;
the front suspension having means to mount a frame over the resilient dampener to the convex rim at a proximal end, having means for one or more roller wheels at a distal end, having means for a vent with open visibility, having means to lower debris and machine weight, having means to maintain a fixed position or dial into more tool height or add width to the operator shield, having means to limit the tool height positions, having means to support the unit in a vertical position over hard pavement surfaces, having means to maintain the line filament or bladed tool behind sensitive frontal property improvements and vegetation at all times, having means to protect the line filament or bladed tool from high resistance over hard pavements and the like at all times; having means to minimize tool disturbances; having means to press down on tall vegetation evenly with the operator shield, having means to limit vegetation wrap around the unit, having means to guide forward progress of the unit, having means to substantially reduce operator and tool fatigue during transport and operation, having means to stow away when the unit is operated along loose or soft grounds cover, having means to align ninety degrees from the nearest operator shield radian side wall and having means to balance the unit during a primary blower operation or the line filament or bladed cutter operations;
the line filament and bladed tool outputs combine for no more than 200 rpm variance of the motor input at wide open throttle, having means to reverse, reciprocate and alter speeds and motions, having means to maximize the cutter and the fan performances while minimizing grounds disturbances, and having means to cool the tool barrier bracket.
